(19) United States
(12) Patent Application Publication
(10) Pub. No.: US 2015/0253502 A1
(43) Pub. Date: Sep. 10, 2015

(54) INTEGRATED CIRCUIT WITH PHOTONIC ELEMENTS

(71) Applicants: Ben-Gurion University of the Negev Research and Development Authority, Beer-Sheva (IL); Bar-Ilan University, Ramat-Gan (IL)

(72) Inventors: Alexander Fish, Tel-Mond (IL); Zeev Zalevsky, Rosh HaAyin (IL); Amihai Meiri, Ramat-HaSharon (IL); Ori Bass, Tel-Aviv (IL)

(21) Appl. No.: 14/427,756

(22) PCT Filed: Sep. 11, 2013
(86) PCT No.: PCT/IL2013/050765

§ 371 Date: Mar. 12, 2015

Related U.S. Application Data
(60) Provisional application No. 61/700,392, filed on Sep. 13, 2012.

(51) Int. Cl. G02B 6/122

(52) U.S. Cl. CPC G02B 6/1225

(57) ABSTRACT

An integrated circuit with electronic and photonic elements includes: at least one electronic processing layer; at least one interconnect layer adjacent to said electronic processing layer, and at least one photonic element located within a respective interconnect layer. The photonic elements implement respective operations upon optical signals. At least a portion of each interconnect layer which includes photonic elements is optically-conductive, and therefore suitable for the inclusion of the photonic elements.

In some embodiments said photonic elements comprising optical waveguides are configures as optical logic gates to perform logic operations.

### FIELD AND BACKGROUND OF THE INVENTION

The present invention, in some embodiments thereof, relates to an integrated circuit which includes photonic elements, such as photonic logic gates, formed within interconnect layers, and, more particularly, but not exclusively, to an integrated circuit with an optical memory bitcell formed within the interconnect layers.

Many efforts have been made to develop small and fast electronic devices which achieve high reliability with aggressive technology scaling. However, the speed and reliability of electronic devices are limited by electronic interference and low mobility of electrons. With advancements in technology and continuous process scaling, power dissipation of VLSI chips has become one of the fundamental limits in both high performance microprocessors and low to medium performance portable systems. Additionally, the requirement to integrate a variety of functions, such as digital and analog computation, memories, sensing, interconnect in a single VLSI system, has recently led to attempts to develop alternative approaches, such as 3D VLSI.

Recently, electro-optical and all optical devices have been proposed as an alternative to conventional transistors and logic gates. The advantages of optical devices over conventional electronics include relative immunity to electronic interference, high SNR, high bandwidth and low channel crosstalk. For example, such an optical gate was presented “Nanophotonic interferometer realizing all-optical exclusive or gate on a silicon chip,” Opt. Eng., vol. 48, pp. 064601, June 2009, by O. Limon and Z. Zalevsky.

Many of the proposed optical devices are developed for implementation in conventional silicon fabrication processes; however they are still not suitable for implementation in state-of-the-art VLSI CMOS processes. While allowing feature sizes of 40 nm and below, these processes present very high variability of the fabricated devices and therefore significantly affect the performance and reliability of optical devices.

Additional Background Art Includes:
1) D. Hisamoto, Wen-Chin Lee, J. Kedzierski, H. Takeuchi, K. Asano, C. Kuo, E. Anderson, Tsu-Jae King, J. Bokor and Chenming Hu, “FinFET-a self-aligned double-gate MOSFET scalable to 20 nm,” Electron Devices, IEEE Transactions on, vol. 47, pp. 2320-2325, 2000.
2) S. Bhunia and K. Roy, “Low power design under parameter variations,” in Low Power Electronics and Design (ISLPED), 2008 ACM/IEEE International Symposium on, pp. 137-138, 2008.
3) V. F. Pavlidis and E. G. Friedman, “Three-Dimensional Integrated Circuit Design”, Morgan . . . Springer, ISBN: 978-3-642-12266-8, 2010.
4) C. Luo, J. D. Joannopoulos, and S. Fan, “Nonlinear photonic crystal micro devices for optical integration,” Opt. Lett. 28, 637-639 (2003).
5) H. Fukuda, K. Yamada, T. Shoji, M. Takahashi, T. Tsuchizawa, T. Watanabe, J.-I. Takahashi, and S.-I. Itabashi, “Four-wave mixing in silicon wire waveguides,” Opt. Express 13, 4629-4637 (2005).
6) E. D. Palik, “Handbook of Optical Constants of Solids,” 1985, pp. 280-288.
7) A. Yariv, “Coupled-mode theory for guided-wave optics,” Quantum Electronics, IEEE Journal of, vol. 9, pp. 919-933, 1973.

### SUMMARY OF THE INVENTION

According to an aspect of some embodiments of the present invention there is provided an integrated circuit with electronic and photonic elements. The integrated circuit includes: at least one electronic processing layer; at least one interconnect layer adjacent to the electronic processing layer; and at least one photonic element located within a respective interconnect layer, configured to implement a respective operation upon optical signals. At least a portion of the interconnect layer is optically-conductive.

According to some embodiments of the invention, at least one of the photonic elements includes a photonic logic gate configured to perform a respective logic operation upon optical logic signals.

According to some embodiments of the invention, the integrated circuit includes at least two photonic elements respectively located within separate interconnect layers.

According to some embodiments of the invention, the integrated circuit includes at least two photonic elements located within a same interconnect layer.

According to some embodiments of the invention, the electronic processing and interconnect layers alternate, so as to separate between the electronic processing layers.

According to some embodiments of the invention, at least one of the photonic elements includes a nanometric interferometer configured for generating interference effects between input optical signals.

According to some embodiments of the invention, at least one of the photonic elements includes: a first optical waveguide configured to guide a first input optical signal; a second optical waveguide configured to guide an output optical signal; a third optical waveguide configured to guide a second input optical signal; a first metallic layer separating between the first optical waveguide and the second optical waveguide; a second metallic layer separating between the second optical waveguide and the third optical waveguide. The metallic layers are configured to create relative phase shifts between optical signals guided by the optical waveguides, such that a combination of the guided optical logic signals yields the respective operation at an output of the photonic element. According to some embodiments of the invention, the first and third optical waveguides include logic inputs, the second optical waveguide includes a logic output, and the respective logic operation is an XNOR operation. According to alternate embodiments of the invention, the first and second optical waveguides include logic inputs, the second optical waveguide further includes a logic output, and the respective logic operation is an XOR operation. According to some embodiments of the invention, the third optical waveguide includes a reference beam input.

According to some embodiments of the invention, at least one of the photonic elements includes a nanometric interferometer followed by an amplification element, and configured to provide a NAND logic operation. The nanometric interferometer is configured for inputting a first and second optical logic inputs and a reference input, and for outputting an optical signal is a sum of the first and second optical logic inputs minus the reference signal. The amplification element is configured for amplifying an output of the nanometric interferometer to a saturation level.

According to some embodiments of the invention, at least one of the photonic elements is a light bender configured for conveying optical signals between separate interconnect layers.

According to some embodiments of the invention, at least one of the photonic elements is an optical coupler configured for coupling between a plurality of the photonic elements.

According to some embodiments of the invention, at least one of the photonic elements includes an optical losses compensator configured for compensating for losses in optical logical signal intensity. According to further embodiments of the invention, the optical losses compensator includes a light-emitting element configured for optically-pumping quantum dots implanted within an interconnect layer.

According to some embodiments of the invention, at least one of the photonic elements is a modulator.

According to some embodiments of the invention, an optical waveguide includes a channel of a first optically-conductive substance enclosed by a second optically-conductive substance. According to further embodiments of the invention, the second optically-conductive substance includes an interconnect layer substrate material.

According to some embodiments of the invention, at least one of the photonic elements is a memory bitcell. The bitcell includes: a first optical NAND gate located on a first interconnect layer; a second optical NAND gate located on a second interconnect layer; a plurality of light benders configured for conveying optical signals between the first and second interconnect layers, such that the first and second optical NAND gates are cross-coupled; and an optical losses compensator configured for compensating for losses in optical signal intensity within the bitcell. According to some embodiments of the invention, the bitcell further includes a plurality of optical couplers, respectively associated with a respective light bender, each of the optical couplers being configured for splitting and combining optical signals.

According to an aspect of some embodiments of the present invention there is provided a method for providing an integrated circuit with electronic and photonic elements. The method includes: providing a first electronic processing layer; and providing a first interconnect layer adjacent to the first electronic processing layer. At least a portion of the interconnect layer is optically-conductive. The interconnect layer includes at least one photonic element configured to implement a respective operation upon optical signals.

According to some embodiments of the invention, the method further includes: providing a second electronic processing layer adjacent to the first interconnect layer; and providing a second interconnect layer adjacent to the second electronic processing layer. At least a portion of the second interconnect layer is optically-conductive. The second interconnect layer includes at least one photonic element configured to implement a respective operation upon optical signals.

According to some embodiments of the invention, at least one of the photonic elements is a photonic logic gate configured to perform a respective logic operation upon optical logic signals.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram of an integrated circuit with electronic and photonic elements, in accordance with embodiments of the present invention;

FIGS. 2A and 2B are simplified block diagrams of photonic elements, according to embodiments of the present invention;

FIG. 3 is a simplified block diagram of a light bender, in accordance with an exemplary embodiment of the present invention;

FIGS. 4 and 5 illustrate simulation results for a light bender following an optical XOR logic gate;

FIG. 6A is a simplified block diagram of NAND-based optical memory bitcell, in accordance with embodiments of the present invention;

FIG. 6B is a simplified flowchart of a method for providing an integrated circuit with electronic and photonic elements, according to embodiments of the present invention;

FIG. 7A is a simplified block diagram of an optical NAND gate, in accordance with embodiments of the present invention;

FIG. 7B is a simplified block diagram of an XOR gate, according to exemplary embodiments of the present invention;

FIGS. 8A and 8B are simulation results showing the energy propagation through an exemplary XOR gate with energy input into a single input waveguide;

FIG. 8C illustrates the energy propagation through an exemplary XOR gate with energy input into both input waveguides;

FIGS. 9A and 9B show the exemplary XOR gate extinction ratio and insertion loss respectively, in the presence of size variations in the interior waveguide for different gate lengths;

FIGS. 10A and 10B show the exemplary XOR gate extinction ratio and insertion loss respectively, in the presence of asymmetric variations in metal thickness;

FIGS. 11A and 11B show the exemplary XOR gate extinction ratio and insertion loss respectively, in the presence of asymmetric variations in exterior waveguides thickness;

FIG. 12 is a simplified block diagram of an XNOR gate, according to exemplary embodiments of the present invention;

FIGS. 13A and 13B are simulation results showing the energy propagation through an exemplary XNOR gate for two input signals having the same phase;

FIGS. 14A and 14B illustrate the energy propagation through an exemplary XNOR gate for two input signals which are different in phase;

FIG. 15A shows an achieved ratio R in the presence of asymmetric variations in the sizes of the external waveguides of an exemplary XNOR gate;

FIG. 15B shows an achieved ratio R in the presence of asymmetric variations in the metal thickness of an exemplary XNOR gate;

FIG. 15C shows an achieved ratio R in the presence of asymmetric variations in the size of the internal waveguide of an exemplary XNOR gate; and

FIG. 16 is a simplified block diagram of is a simplified block diagram of a NOR-based optical memory bitcell, in accordance with embodiments of the present invention.

### DESCRIPTION OF SPECIFIC EMBODIMENTS OF THE INVENTION

The present invention, in some embodiments thereof, relates to an integrated circuit which includes photonic elements, such as photonic logic gates, formed within interconnect layers, and, more particularly, but not exclusively, to an integrated circuit with an optical memory bitcell formed within the interconnect layers.

An integrated circuit (also denoted herein an IC or chip) is an electronic processing circuit, typically created upon the surface of a thin substrate of semiconductor material. Additional materials are deposited and patterned to form interconnections between electronic elements within the chip. Typically an IC has multiple electronic processing layers separated by interconnect layers. The interconnect layers carry wiring between the electronic elements.

The interconnect layers also serve to isolate the various electronic processing layers from each other, and thus are formed, at least in part, from electrically non-conductive materials.

The claimed embodiments incorporate optical elements (also denoted photonic elements) within interconnect layers of the IC. Thus additional functionality may be added to an IC without consuming electronic processing layer resources.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

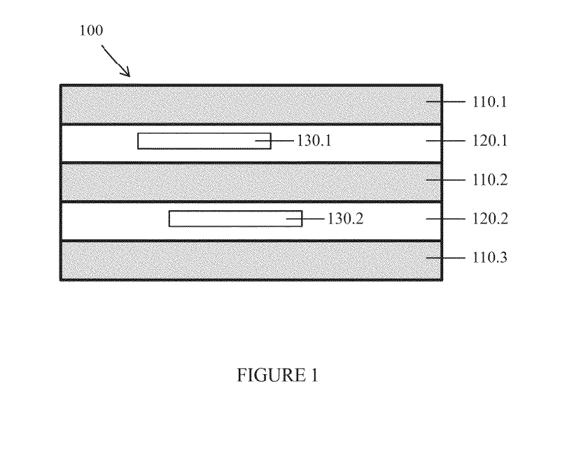

Reference is now made to FIG. 1, which is a simplified block diagram of an integrated circuit with electronic and photonic elements, in accordance with embodiments of the present invention. Integrated circuit 100 includes at least one electronic processing layer 110 and at least one interconnect layer 120. The interconnect layers and electronic processing layers alternate, thus isolating between the electronic processing layers. IC 100 further includes at least one photonic element 130 located within an interconnect layer. The photonic elements perform respective operations or functions upon input optical signals. In some embodiments at least one of these optical elements is a photonic logic element (also denoted herein a photonic logic gate) which performs a logic operation upon input optical logic signals.

The term “optical element” (also denoted a photonic element) means any element formed in order to produce an effect upon an optical signal or signals.

As used herein the term “interconnect layer” means a layer within the integrated circuit which contains metal interconnections between electronic elements within the IC. At least a portion of the interconnect layer is optically-conductive, enabling the passage of optical signals. An interconnect layer may comprise an oxide-layer.

As used herein the term “electronic processing layer” means allayer suitable for implementing the electronic components within the IC. Typically the electronic processing layer is formed as semiconductor electronic components (e.g. transistors) upon a silicon substrate.

In the non-limiting exemplary embodiment of FIG. 1, IC 100 includes three electronic processing layers 110.1-110.3 alternating with two interconnect layers 120.1-120.2. Photonic elements 130.1-130.2 are located on interconnect layers 120.1-120.2 respectively. It is to be understood that the number of photonic elements, electronic processing layers and interconnect layers may vary, in accordance with the complexity and requirements of the integrated. It is also to be understood that the distribution of the photonic elements amongst the interconnect layers may also vary. A given interconnect layer may contain multiple photonic elements. Some interconnect layers may contain no photonic elements. Photonic elements may be interconnected within the IC in stacked and/or cascaded configurations.

### A. Photonic Interferometer Elements

In some embodiments the photonic elements incorporated into the interconnect layers operate as nanometric interferometers. One way to create the interference effect is to create metallic layers between optical waveguides, as is now described.

In some embodiments a photonic logic element includes two or more optical waveguides. Adjacent waveguides are separated by metallic layers. The waveguide dimensions and metallic layer widths are selected to obtain the required logic function.

The metal layer creates relative phase shifts between optical logic signals guided by the optical waveguides. The phase shifted signals then combine constructively or destructively at the output, resulting in the required operation. Selecting a metal, such as chromium, which is compatible with standard micro-electronic fabrication processes may simplify inclusion of the optical element within the interconnect layer. However other metals may be used.

The optical phase may be destroyed by using a light source such as an LED, with a sufficiently wide bandwidth (e.g. a few tens of nm) to make the illumination temporally incoherent.

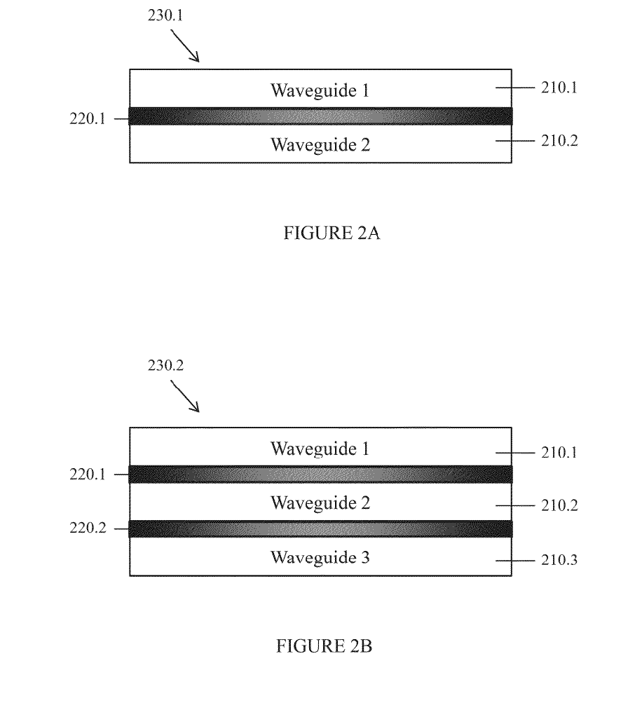

Reference is now made to FIGS. 2A and 2B are simplified block diagrams of photonic elements, according to embodiments of the present invention.

FIG. 2A shows a two-waveguide logic gate 230.1, formed from optical waveguides 210.1 and 210.2. Metallic layer 220.1 separates between the optical waveguides, creating a phase shift between photonic logic signals guided by the waveguides.

FIG. 2B shows a three-waveguide logic gate 230.2. Logic gate 230.2 includes an additional optical waveguide 210.3 and additional metallic layer 220.2 as shown.

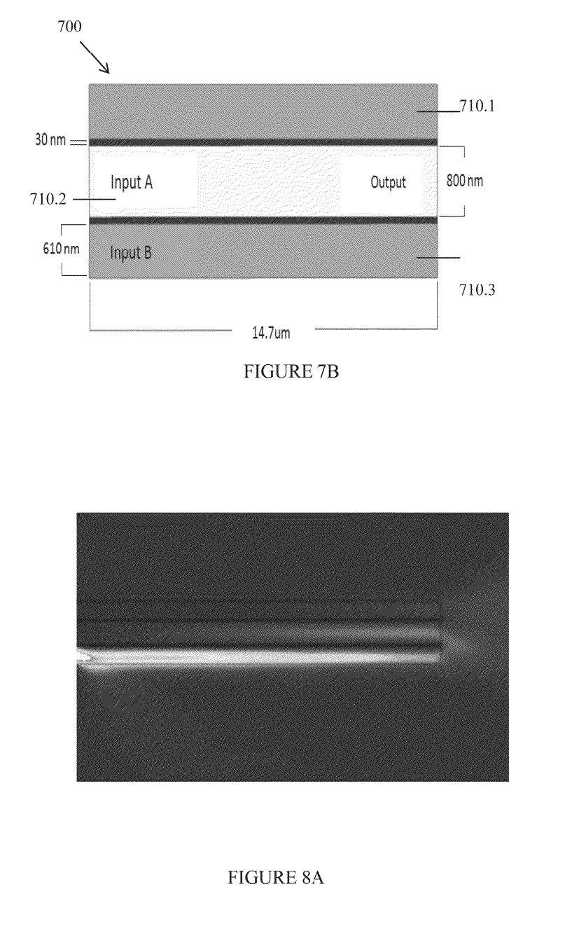

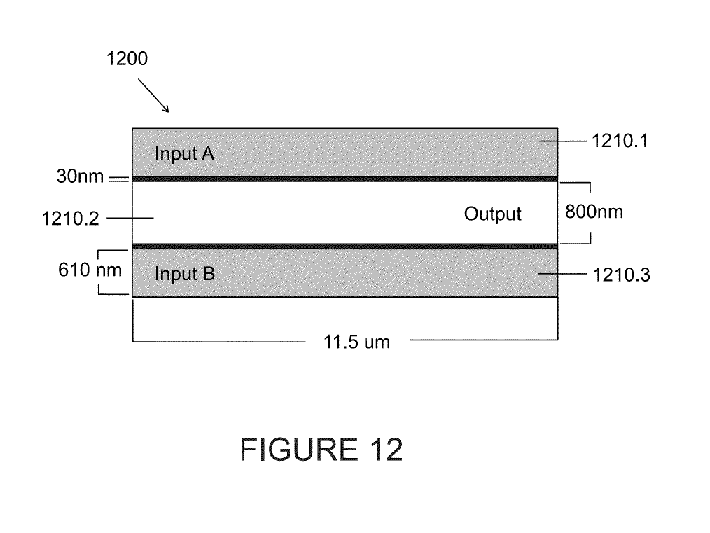

Such structures may be suited for implementing photonic logic functions. Exemplary embodiments of photonic XOR and XNOR logic elements having a three-waveguide structure are described below (see FIGS. 7B and 12 respectively). It is to be noted that similar structures may serve for implementing other types of optical functions, and are not limited to implementation of logic gates.

### B. Optical Waveguides

Optical waveguides may be formed within an interconnect layer by any means known in the art. For example, a properly-dimensioned channel of an optically-conductive substance may be formed within the interconnect layer substrate. The difference in refractive indexes of the interconnect layer and the surrounding medium gives rise to confinement of optical propagation modes and allows guiding of the optical signals within the waveguide. Other possible implementations include, but are not limited to, strip waveguide and rib waveguide.

### C. Types of Optical Elements

Various types of optical elements may be formed within the interconnect layers. Connections may be formed between photonic elements on the same interconnect layer, or upon different interconnect layers. In this way complex optical circuits may be created within a single IC chip.

The optical elements may include one or more of the following:

a) A photonic logic gate.

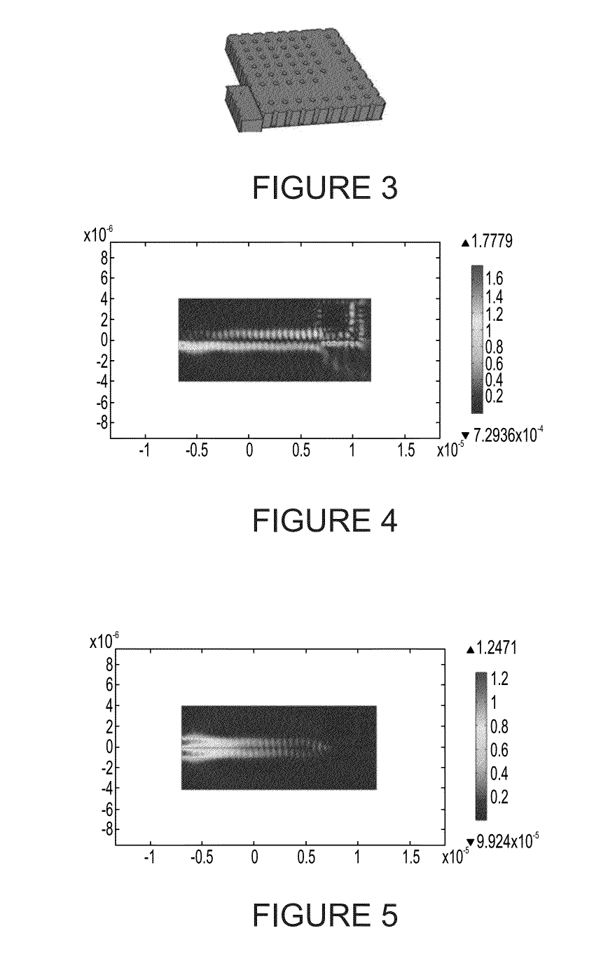

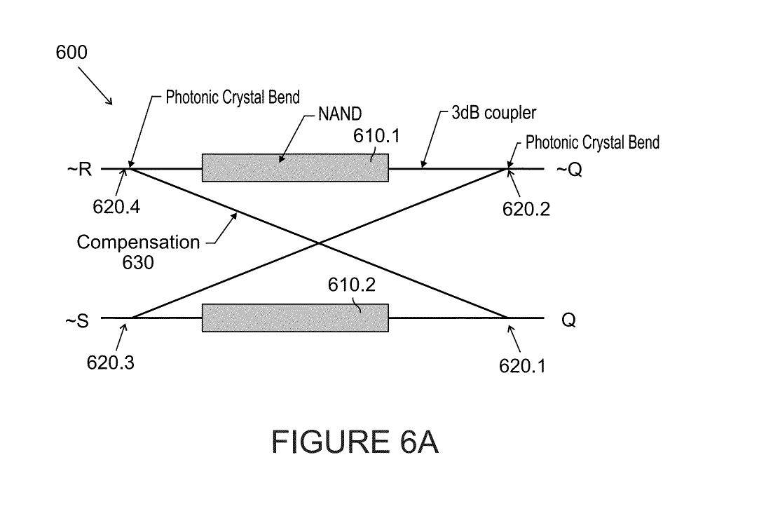

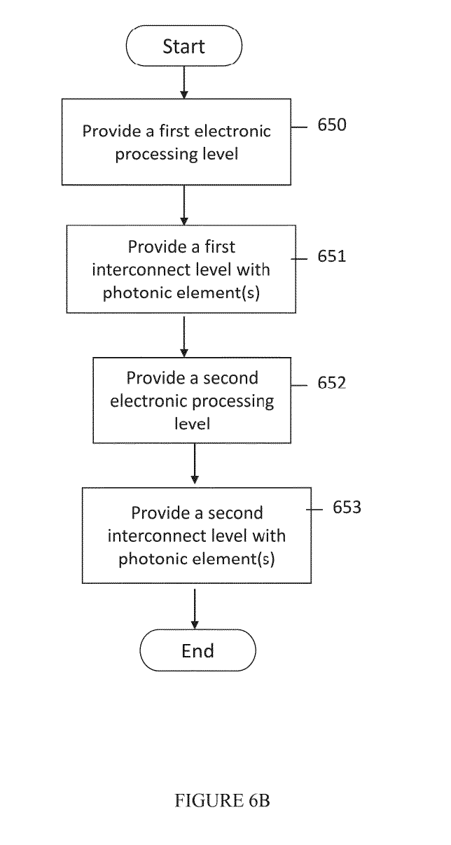

b) A light bender which conveys optical signals between interconnect layers. An exemplary embodiment of a light bender is illustrated in FIG. 3. Simulation results for the light bender are shown in FIGS. 4 and 5. FIGS. 4 and 5 present simulation results for a light bender following an optical XOR logic gate. FIG. 4 shows simulation results for 1-0 logic inputs, whereas FIG. 5 shows simulation results for 1-1 logic inputs. The figures illustrate a single oxide layer, with the output of the logic gate bent towards an upper oxide layer.

c) An optical coupler which couples between photonic elements. A coupling effect may also be obtained by positioning a light bender or other element at a proper distance from the output of the preceding optical element.

d) An optical amplifier which amplifies optical input signals. The amplifier may serve as an optical losses compensator which compensates for losses in optical signal intensity within and/or between the photonic elements. In some embodiments the optical losses compensator may include a light-emitting element (such as an LED) which optically-pumps quantum dots implanted within the interconnect layer. In other embodiments the amplification is provided by nanometric holes.

e) Subtraction optical element which subtracts a constant value from an optical signal. In some embodiments the subtraction optical element is implemented as an interferometer.

f) An optical interferometer element.

g) Additional optical waveguides.

### D. Photonic Memory

In many systems SRAM blocks occupy the majority of SoC die area and most of the chip's leakage comes from the SRAM cells. A popular SRAM bitcell structure is the standard 6T bitcell. However, the 6T SRAM is very large and loses functionality when operated at low supply voltages, due to process variations and mismatch.

By constructing the SRAM portion of the IC in the interconnect layers, large silicon areas are freed up for other implementations. Moreover, several optical memory arrays may be “stacked” on top of each other in different interconnect layers, allowing the implementation of a “3D memory” upon a single die. The optical memory may be more efficient in terms of power dissipation, writing/readout speed, sensitivity to process variations and operation robustness under read and write operations.

Exemplary embodiments of a photonic SRAM memory bitcell utilizing the interconnect layers of the IC chip are now described. The memory bitcell described herein is compatible with standard CMOS fabrication processes.

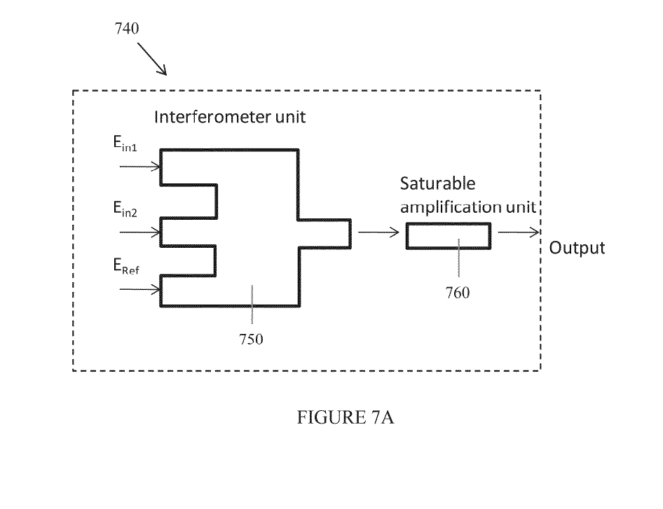

Reference is now made to FIG. 6A, which is a simplified block diagram of a NAND-based optical memory bitcell, in accordance with embodiments of the present invention. In the embodiment of FIG. 6A, each of the NAND logic gates may be implemented in a different interconnect layer. In other embodiments the NAND logic gates may be placed on the same interconnect layer.

The expected dimensions of the core of bitcell 600 are approximately 15 um by 1.5 um and occupy two oxide layers. Note that the optical bitcell occupies portions of the chip that are currently unused for any purpose other than interconnection and electrical insulation.

Bitcell 600 is a photonic implementation of an SR latch having a cross-coupled NAND gate configuration. Bitcell 600 includes the following optical elements:

a) Optical logic NAND gates 610.1 and 610.2. An exemplary embodiment of a photonic NAND gate is described below (see FIG. 7A);

b) Light benders 620.1-620.4—In some embodiments light benders 620.1-620.4 are formed with the light bending configuration of FIG. 3. The holes bend the light so as to transfer the optical signals between different interconnect layers, thus enabling a stacked configuration with NAND gates in separate interconnect layers;

c) Photonic couplers/combiners (3 dB)—In some embodiments a photonic coupler/combiner is implemented as a waveguide splitting the incoming light in two with 3 dB losses; and

d) Losses compensator 630—Compensates for the 3 dB loss caused by the coupling. In some embodiments quantum dots (QD) are implanted in the specified locations in the interconnect layer. The QD performs the required 3 dB compensation. The dots may be optically pumped by a dedicated pumping LED. In such embodiments, the memory cell requires two types of LEDs, the readout/data writing command LED and the pumping LED that maintains the operability of the cascaded configuration (these LEDs may be shared for some or even all bitcells in the arrays, according to the architectural concept of the memory array).

In some embodiments the average optical power worked with is 1 μW. The pumping LED of losses compensator 630 may also inject 1 μW.

Multiple optical bitcells may be combined into memory arrays by any means known in the art.

Communication with the on-chip logic and interfacing with external optical signals and/or sources may be performed by any means known in the art.

Reference is now made to FIG. 6B which is a simplified flowchart of a method for providing an integrated circuit with electronic and photonic elements, according to embodiments of the present invention. The method herein provides alternating electronic processing and interconnect layers, where at least one photonic element is included in the interconnect layer or layers. FIG. 6B illustrates an exemplary embodiment with two electronic processing layers and two interconnect layers, where each interconnect layer includes photonic element(s).

In 650 a first electronic processing layer is provided. In 651 a first interconnect layer is provided adjacent to the first electronic processing layer. The first interconnect layer includes at least one photonic element.

In 652 a second electronic processing layer is provided. In 653 a second interconnect layer is provided adjacent to the second electronic processing layer. The second interconnect layer includes at least one photonic element.

The integrated circuit described herein introduces optical elements into the previously unutilized interconnect layers. In this manner, the capabilities of the integrated circuit may be increased dramatically without detracting from the circuit's electronic components. Due to the inherent properties of optical devices, the integration of optical elements reduces leakage and provides high power efficiency and improved speed.

It is expected that during the life of a patent maturing from this application many relevant optical elements, memory cells, memory array configurations, and IC fabrication techniques, materials and achievable dimensions, will be developed and the scope of the corresponding terms is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find calculated support in the following examples.

### Examples

Reference is now made to the following examples, which together with the above descriptions illustrate some embodiments of the invention in a non limiting fashion.

### E. NAND Photonic Logic Element

Reference is now made to FIG. 7A, which is a simplified block diagram of an optical NAND gate, in accordance with embodiments of the present invention. NAND gate 740 includes nanometric interferometer 750 and amplification unit 760. The phase may be destroyed by using spectrally non-monochromatic light source.

The inputs into interferometer 750 are the two logic bit streams (Eᵢₙ₁ and Eᵢₙ₂) and a constant reference beam E_{Ref}. The reference beam intensity is twice the intensity of Eᵢₙ₁ and Eᵢₙ₂. In other words, given a level of “0” or “1” for the logic inputs (Eᵢₙ₁ and Eᵢₙ₂) the intensity of the reference beam (E_{Ref}) which is inserted into nanometric interferometer 750 is at a constant level of “2”.

Nanometric interferometer 750 performs the operation:

Out=Eᵢₙ₁+Eᵢₙ₂−E_{Ref} (1)

Table 1 shows a lookup table for a NAND gate with inputs Eᵢₙ₁ and Eᵢₙ₂, and also shows the output of nanometric interferometer 750:

TABLE 1

| | | | Out = |
|---|---|---|---|
| Eᵢₙ₁ | Eᵢₙ₂ | NAND | 2 − (Eᵢₙ₁ + Eᵢₙ₂) |
| 0 | 0 | 1 | 2 |
| 0 | 1 | 1 | 1 |
| 1 | 0 | 1 | 1 |
| 1 | 1 | 0 | 0 |

The output of interferometer 750 is connected to a saturable amplification unit 760 which may be implemented by any gain medium known in the art, for example a saturable absorber, quantum dots etc. The amplification unit amplifies interferometer output to a saturation level of “2”, so that a “2” output level will remain at 2 (the saturation level) while a level of “1” will be amplified to “2”. A level of “0” will remain at 0. Thus, the NAND functionality of Table 1 is realized.

In some embodiments, interferometer 750 has a three-waveguide structure similar to the structure shown in FIG. 2B.

### F. XOR Photonic Logic Element

In order to integrate photonic logic into ICs in an efficient and cost-effective manner, it is desirable to design the optical elements with materials and dimensions which are achievable with current fabrication processes. This section presents a photonic XOR logic element which utilizes the principles of coupling mode theory to perform an XOR logic operation. The XOR logic element described herein is suitable for fabrication in a standard CMOS nano-scaled process (with dimensions of 40 nm and below) and may be implemented using the existing interconnect layers of a VLSI chip. Thus both electronic and optical computation (logic and memory) may be implemented and integrated on the same chip without affecting each other and saving area. The unique structure of the proposed device provides a significant reduction of sensitivity to process variations in state-of-the-art nanoscale processes. It also achieves very small physical dimensions, compared to existing optical gates.

Reference is now made to FIG. 7B which is a simplified block diagram of an XOR gate, according to exemplary embodiments of the present invention. XOR gate 700 has a three-waveguide structure (similar to the structure shown in FIG. 2B). Exterior waveguide 710.3 serves as a logic input (Input B) to XOR gate 700. The interior waveguide (710.2) functions both as the second input (Input A) and as the XOR gate output. The gate makes use of materials which are standard in a conventional VLSI CMOS process. Silicon dioxide (SiO₂) with a refractive index of n=1.48 may be used for the waveguide implementations, and copper (Cu) with a refractive index of N=0.606−j8.26 for metal implementations.

The dimensions of exemplary XOR gate 700 are as follows: the input waveguides are 610 nanometer (nm) wide, output waveguide has a width of 800 nm, the thickness of the metal layers is 30 nm and the length of the device is 14.7 micrometer. As shown below, XOR gate 700 is very robust to variations with these dimensions. A light wavelength of 1.55 μm, which is standard in optics communication, was assumed while designing the proposed device.

According to the coupling mode theory, the electric field between two identical waveguides in the presence of a slab may be expressed by:

E=A(z)E₁+B(z)E₂ (2)

where Eᵢ is the i'th waveguide electric field and A(z) and B(z) are the amplitudes as a function of the propagation distance z. A(z) and B(z) are given by:

A(z)=cos(κz)A(0)−j sin(κz)B (0)

B(z)=−j sin(κz)A(0)+cos(κz)B(0) (3)

where κ is the coupling coefficient and z is the position along the z-axis. The effect occurs between each pair of waveguides, causing an elaborate interaction between them.

The metal between the waveguides accumulates phase differences which depends on the width of the metal. The three-waveguide structure accumulates the phase difference more rapidly (in comparison with a two-waveguide structure). The energy finally accumulates and builds up at the end of the device in order to create the amplitude modulated XOR logic function.

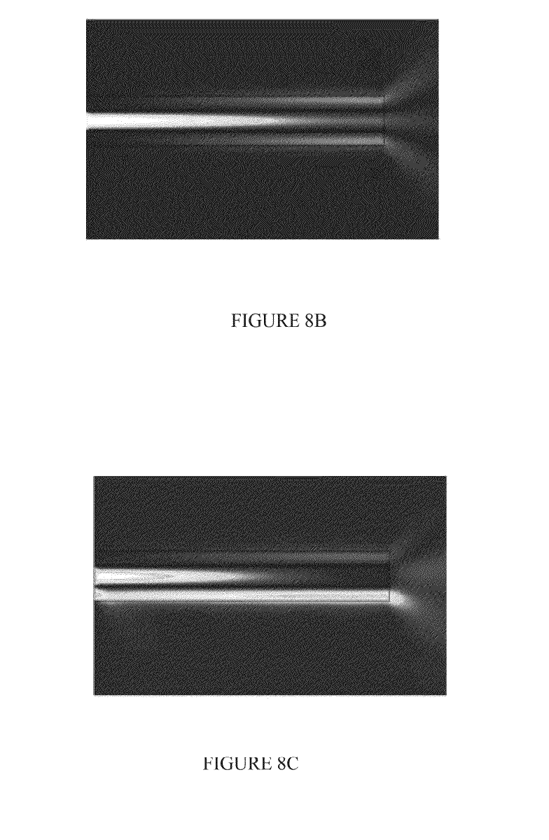

Reference is now made to FIGS. 8A and 8B, which are simulation results showing the X axis energy accumulation when opposite logic levels are input into the A and B inputs. In FIG. 8A energy is input into waveguide 710.2 (Input A) and not into waveguide 710.3 (Input B), whereas in FIG. 8B energy is input into waveguide 710.3 (Input B) and not into waveguide 710.2 (Input A). It is seen that when opposite logic levels are input into XOR gate 700, energy is output from the opposite end of interior waveguide 710.2 (also see Table 2 below).

Reference is now made to FIG. 8C, which illustrates the X axis energy accumulation when energy is input into both waveguides 710.2 and 710.3 (the A and B inputs respectively). In this case, the different phase accumulation at the input waveguides 710.2 and 710.3 creates a destructive interference and therefore energy does not build up in interior waveguide 710.2.

It may be seen that if input signals with positive amplitude are considered as a logic ‘1’ and signals with zero amplitude are considered as logic ‘0’, XOR gate 700 implements the XOR logical function (amplitude modulation). Table 2 shows exemplary results of the gate operation with input signals having 1 v/m amplitude. The extinction ratio may be calculated (for the above specification) as 25.977 dB.

TABLE 2

| | | Output | Output |
|---|---|---|---|
| A | B | amplitude | Power [w/m\hat{ }²] |
| 0 | 0 | 0 | 0 |
| 1 | 0 | 1 | 1.96427e−10 |
| 0 | 1 | 1 | 1.90871e−10 |
| 1 | 1 | 0 | 4.7967e−13 |

A number of simulations have been carried out to examine the robustness of XOR gate 700 to process variations. XOR gate 700 was examined for specific variations in one of the parameters: waveguide width, length of the device and metal width changes. Simulations were also performed for combinations of variations in the parameters which may cause asymmetric changes in the gate structure. An asymmetric change in the metals widths, for example, may cause phase accumulation between the waveguides.

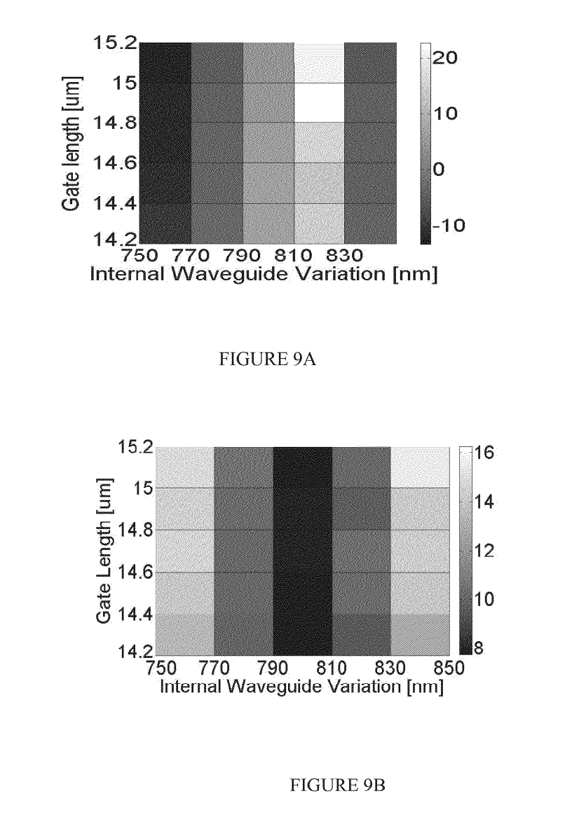

FIG. 9A shows the extinction ratio in the presence of variations in sizes of waveguide 710.2 (Input A) for different gate lengths. FIG. 9B shows the insertion loss under the same variation. As may be seen, the device length has little influence on the extinction ratio and on the insertion loss. In contrast, the width of interior waveguide 710.2 has a significant influence on the extinction ratio and on the insertion loss.

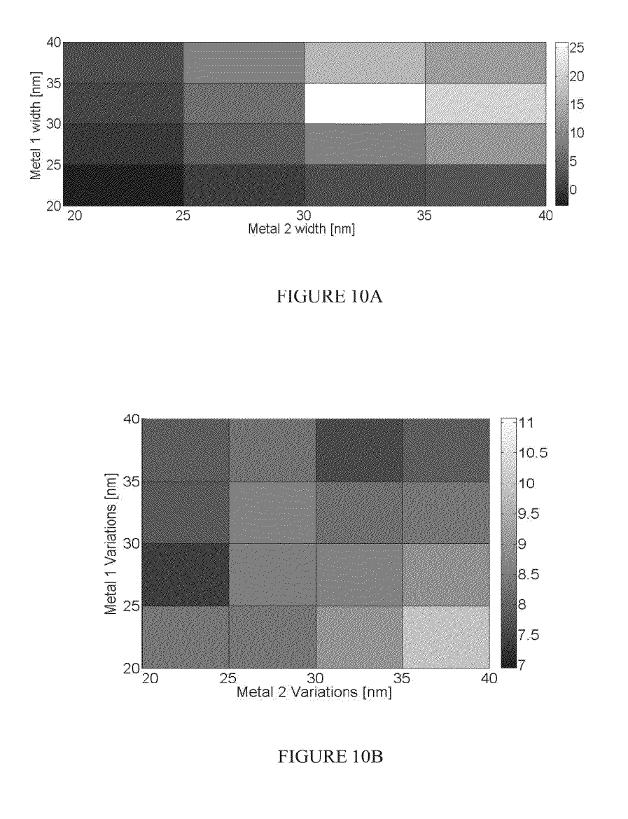

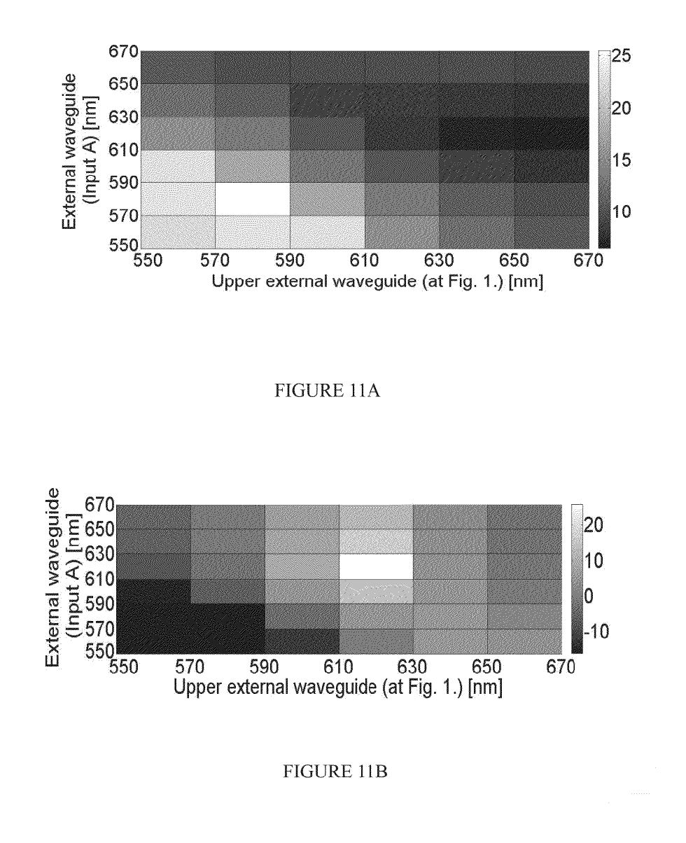

The influences of asymmetric variations in the metal thickness are shown in FIGS. 10A and 10B (for extinction ratio and insertion loss respectively). The influences of different external waveguide variations are shown in FIGS. 11A and 11B (for extinction ratio and insertion loss respectively). It may be seen that the behavior of XOR gate 700 under these variations is robust. As seen in FIG. 10A, for different metal sizes there is a slight change in the insertion loss. As seen in FIG. 10B, the extinction ratio has some degradation but the ratio is still high enough for logic operation.

FIGS. 11A and 11B show the exemplary XOR gate extinction ratio and insertion loss respectively, in the presence of asymmetric variations in exterior waveguides thickness. As seen in FIGS. 11A and 11B, the external waveguide variations are more similar to the metal variations. There is a difference in the influence of variations of the insertion loss and the extinction ratio between the input B waveguide and the metal between the inputs to the other metal and external waveguide. Variations in the sizes of waveguide 710.1 and the first metal layer (between waveguides 710.1 and 710.2) may have less influence on gate operation than variations in the sizes of the second metal layer (between waveguides 710.2 and 710.3) and waveguides 710.2 and 710.3.

The XOR gate 700 measurements shows that its extinction ratio remain with satisfactory limits for a process variation at waveguide 710.2 (input A) of ±2.5%, at waveguide 710.3 (input B) of ±2.5%, at exterior waveguide 710.1 of −6.5%, and of more than +10%, and a ±10 nm variations in the metal thickness, with degradation of up to 2 db.

XOR gate 700 is suitable for fabrication in a standard nanoscaled VLSI CMOS process. The sensitivity of an optical gate to process variations shows that the proposed device present good robustness under process variations. Note that the probably for such asymmetric variations in two adjacent waveguides or metals is low.

### G. XNOR Photonic Logic Element

Reference is now made to FIG. 12 which is a simplified block diagram of an XNOR gate, according to exemplary embodiments of the present invention. XNOR gate 700 has a three-waveguide structure (similar to the structure of XOR gate 700 shown in FIG. 7B). Exterior waveguides 1210.1 and 1210.3 serve as Inputs A and B respectively. Interior waveguide 1210.2 serves as the output waveguide.

The dimensions of exemplary XNOR gate 1200 are as follows: the input waveguides are 610 nanometer (nm) wide, output waveguide has a width of 800 nm, the thickness of the metal layers is 30 nm and the length of the device is 11.5 micrometer. As shown below, XNOR gate 1200 is very robust to variations with these dimensions. A light wavelength of 1.55 μm was assumed while designing the proposed device.

The metal between the waveguides accumulates a phase difference which depends on the width of the metal. The symmetric structure of the proposed gate enables to both external waveguides 1210.1 and 1210.3 to have approximately the same phase difference as the interior waveguide 1210.2. The energy of two exterior waveguides 1210.1 and 1210.3 accumulates in the interior waveguide 1210.2. The energy builds up and reaches the maximum energy at the end of the device.

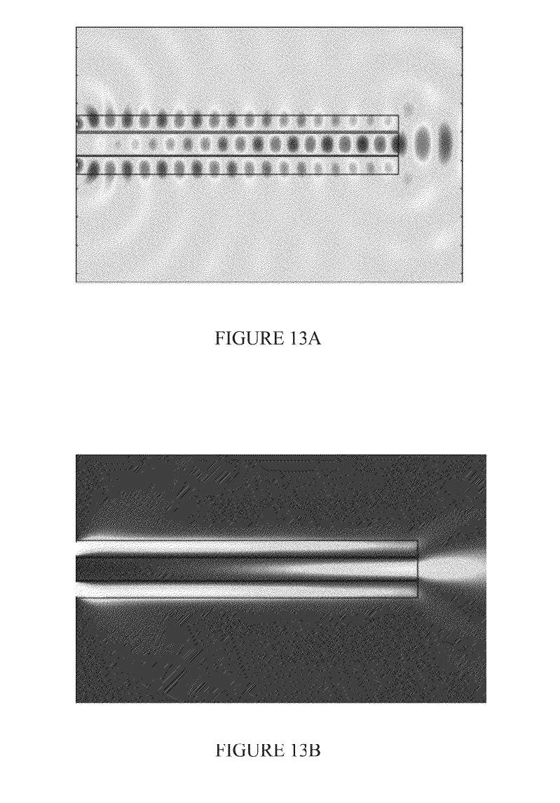

Reference is now made to FIGS. 13A and 13B which are simulation results showing the energy propagation through XNOR gate 1200, for two input signals having the same phase. FIG. 13A depicts the electrical field in the Z axis. FIG. 13B depicts the X axis energy accumulation.

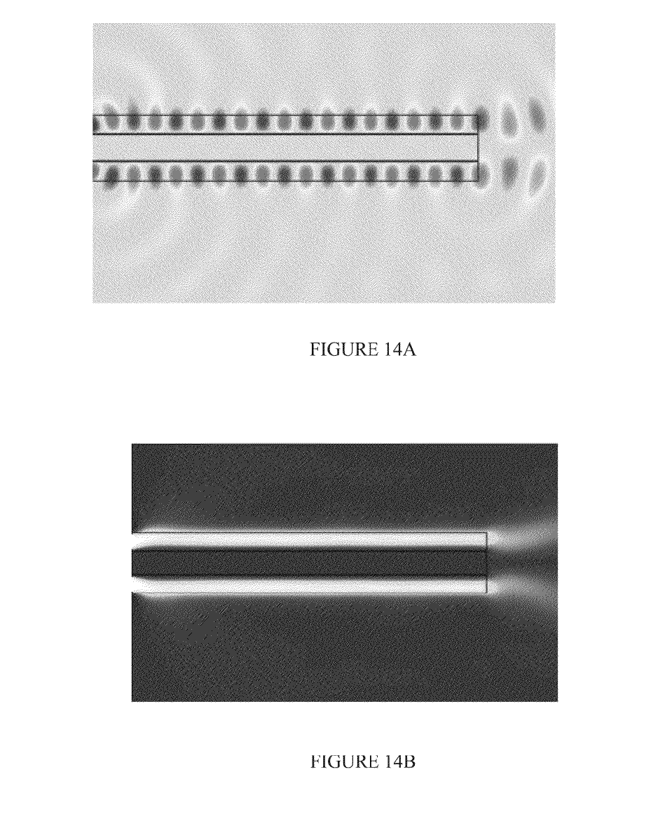

Reference is now made to FIGS. 14A and 14B which illustrate the energy propagation through XNOR gate 1200, for two input signals which are different in phase. In this case a destructive interference occurs and therefore energy does not build up in the internal port. FIG. 14A depicts the electrical field in the Z axis. FIG. 14B depicts the X axis energy accumulation.

It is seen that if input signals with phase 0 are considered as logic signal ‘1’ and signals with phase π are considered as logic signal ‘0’, the proposed device implements the XNOR logic gate.

Table 3 shows an example of the gate operation with input signals having 1 v/m amplitude:

TABLE 3

| | | Output | Output |
|---|---|---|---|
| A | B | amplitude | Power [w/m\hat{ }²] |
| 1 ∠ π | 1 ∠ π | 1 | 5.96951e−10 |
| 1 ∠ π | 1 ∠ 0 | 0 | 1.43529e−11 |
| 1 ∠ 0 | 1 ∠ π | 0 | 1.43529e−11 |
| 1 ∠ 0 | 1 ∠ 0 | 1 | 5.96951e−10 |

The ratio R between the ‘1’ and ‘0’ logic values, which defines the capability of the device to differentiate between ‘1’ and ‘0’, may be calculated as:

$$R = 10 log \frac{logical 1}{logical 0} = 16.19 db \qquad ( 4 )$$

A number of simulations were carried out to examine the robustness of the proposed device to process variations. In the first simulation, a 10% variation in the size of external waveguides (550 nm) and 15% variation in the metal thickness (35 nm) were assumed (these are the typical parameters for a 40 nm process). In this test, a symmetric variation in both metals and external waveguide was assumed. Simulation results showed the 16.18 db ratio between the amplitudes of ‘1’ and ‘0’ logic levels, which is a very slight change from the results achieved by the matched gate.

An additional test is to examine the sensitivity of the proposed device to asymmetric variations, i.e. increase in the dimensions of one waveguide/metal, while the dimensions of another waveguide/metal are decreased. In this case the capabilities of the gate to sustain unsynchronized phases at the device inputs are examined.

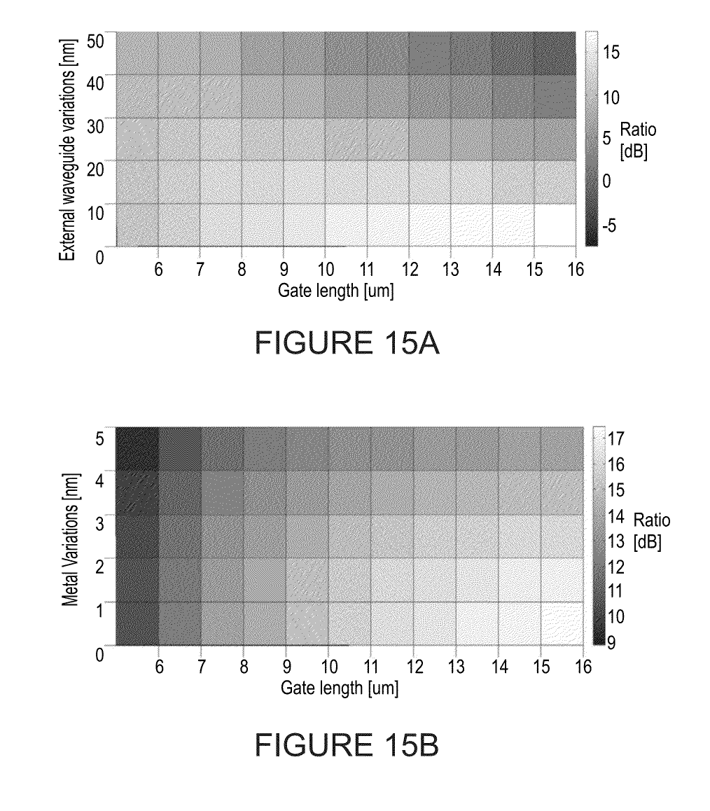

Reference is now made to FIG. 15A which depicts the achieved ratio R in the presence of asymmetric variations in sizes of external waveguides for different gate lengths. As may be seen, the better R may be achieved for longer devices with very small process variations. However, in the presence of significant variations, a short device presents an improved robustness. For example, although a 5 um device achieves the reduced R of 10.5 dB without variations, the degradation in R in the presence of 50 nm asymmetric variations in the waveguides size is only 2.6 db (R=7.9 db). For the long device the degradation in R may be up to 24 dB in the expected worst case.

The influences of asymmetric variations in the metal thickness and the size of the internal waveguide are shown in FIGS. 15B and 15C respectively. It may be seen that the behavior of the device under these variations is very similar to the behavior in FIG. 10A, albeit with a lesser reduction in R.

In summary, XNOR element 1200 presents good robustness even under extreme asymmetric variations of 7%-16%. Note that the probability for such asymmetric variations in two adjacent waveguides or metals is very low.

### H. NOT Photonic Logic Element

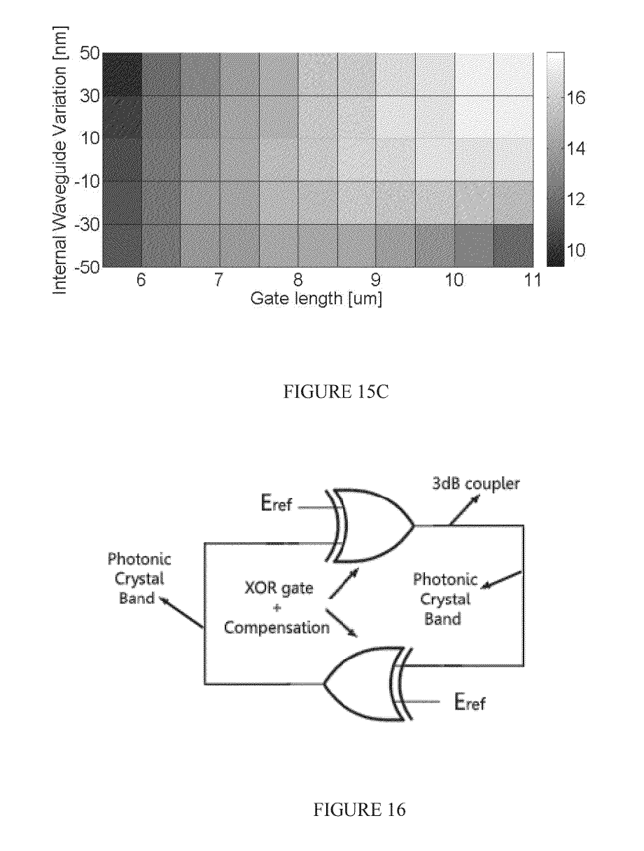

In some embodiments a photonic NOT gate has a structure similar to that of the logic XOR gate of FIG. 7B. Input B is connected to a fixed reference signal and input A serves as the logic input. The realization of the NOT gate is significant as some latch/memory/flip-flop memory cells may be constructed by properly cascading two NOT gates where an input of one gate is connected to the output of the second one as shown in FIG. 16.

One problem which may arise with such a configuration is the transmission losses within the NOT gate, which may affect its performance as a memory cell. To avoid these transmission losses, nanometric holes are generated in upper metal layer (between waveguides 710.1 and 710.2), and to inject additional gain beam through waveguide 710.1 (which does not serve as a logic input). The gain beam injected into waveguide 710.1 is converted to surface plasmons. The interaction of the surface plasmons with the signal in waveguide 710.2 around the nanometric holes creates gain, due to the surface enhanced plasmon resonance effect. Thus the energy of the beam injected into the upper oxide layer is converted into plasmons. The plasmons are converted into photons within waveguide 710.2 or to amplify the photons traveling through waveguide 710.2. The gain thus created compensates for the optical losses due to the propagation through the NOT gate and enables utilizing the configuration of FIG. 7B as part of an optical latch/memory/flip flop. In other embodiments, loss compensation is provided by other gain elements, such as the quantum dot amplification described above.

The nanometric holes in waveguide 710.1 may be formed as an array of holes by any means known in the art, for example by fabricating a 2D net of lines in the upper metal layer while the distance between two adjacent lines in the net is only a few nanometers. The nanometric holes may even be formed by defects in the manufacturing process, without requiring an explicit design and/or manufacturing.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An integrated circuit with electronic and photonic elements, said integrated circuit comprising:
at least one electronic processing layer;
at least one interconnect layer adjacent to said electronic processing layer, wherein at least a portion of said interconnect layer is optically-conductive; and
at least one photonic element located within a respective interconnect layer, configured to implement a respective operation upon optical signals.

2. An integrated circuit according to claim 1, wherein at least one of said photonic elements comprises a photonic logic gate configured to perform a respective logic operation upon optical logic signals.

3. An integrated circuit according to claim 1, comprising at least two photonic elements respectively located within separate interconnect layers.

4. An integrated circuit according to claim 1, comprising at least two photonic elements located within a same interconnect layer.

5. An integrated circuit according to claim 1, wherein said electronic processing and interconnect layers alternate, so as to separate between said electronic processing layers.

6. An integrated circuit according to claim 1, wherein at least one of said photonic elements comprises a nanometric interferometer configured for generating interference effects between input optical signals.

7. An integrated circuit according to claim 1, wherein at least one of said photonic elements comprises:
a first optical waveguide configured to guide a first input optical signal;
a second optical waveguide configured to guide an output optical signal;
a third optical waveguide configured to guide a second input optical signal;
a first metallic layer separating between said first optical waveguide and said second optical waveguide;
a second metallic layer separating between said second optical waveguide and said third optical waveguide;
wherein said metallic layers are configured to create relative phase shifts between optical signals guided by said optical waveguides, such that a combination of said guided optical logic signals yields said respective operation at an output of said photonic element.

8. An integrated circuit according to claim 7, wherein said first and third optical waveguides comprise logic inputs, said second optical waveguide comprises a logic output, and said respective logic operation comprises an XNOR operation.

9. An integrated circuit according to claim 7, wherein said first and second optical waveguides comprise logic inputs, said second optical waveguide further comprises a logic output, and said respective logic operation comprises an XOR operation.

10. An integrated circuit according to claim 7, wherein said third optical waveguide comprises a reference beam input.

11. An integrated circuit according to claim 1, wherein at least one of said photonic elements comprises:
a nanometric interferometer followed by an amplification element, configured for inputting a first and second optical logic inputs and a reference input, and for outputting an optical signal comprising a sum of said first and second optical logic inputs minus said reference signal; and
an amplification element associated with said nanometric interferometer, configured for amplifying an output of said nanometric interferometer to a saturation level,
so as to provide a NAND logic operation.

12. An integrated circuit according to claim 1, wherein at least one of said photonic elements comprises a light bender configured for conveying optical signals between separate interconnect layers.

13. An integrated circuit according to claim 1, wherein at least one of said photonic elements comprises an optical coupler configured for coupling between a plurality of said photonic elements.

14. An integrated circuit according to claim 1, wherein at least one of said photonic elements comprises an optical losses compensator configured for compensating for losses in optical logical signal intensity.

15. An integrated circuit according to claim 14, wherein said optical losses compensator comprises a light-emitting element configured for optically-pumping quantum dots implanted within an interconnect layer.

16. An integrated circuit according to claim 1, wherein at least one of said photonic elements comprises a modulator.

17. An integrated circuit according to claim 1, wherein an optical waveguide comprises a channel of a first optically-conductive substance enclosed by a second optically-conductive substance.

18. An integrated circuit according to claim 17, wherein said second optically-conductive substance comprises an interconnect layer substrate material.

19. An integrated circuit according to claim 1, wherein at least one of said photonic elements comprises a memory bitcell, said bitcell comprising:
a first optical NAND gate located on a first interconnect layer;
a second optical NAND gate located on a second interconnect layer;
a plurality of light benders configured for conveying optical signals between said first and second interconnect layers, such that said first and second optical NAND gates are cross-coupled; and
an optical losses compensator configured for compensating for losses in optical signal intensity within said bitcell.

20. An integrated circuit according to claim 19, said bitcell further comprises a plurality of optical couplers, respectively associated with a respective light bender, each of said optical couplers being configured for splitting and combining optical signals.

21. A method for providing an integrated circuit with electronic and photonic elements, comprising:
providing a first electronic processing layer; and
providing a first interconnect layer adjacent to said first electronic processing layer, wherein at least a portion of said interconnect layer is optically-conductive, said interconnect layer comprising at least one photonic element configured to implement a respective operation upon optical signals.

22. A method according to claim 21, further comprising:
providing a second electronic processing layer adjacent to said first interconnect layer; and
providing a second interconnect layer adjacent to said second electronic processing layer, wherein at least a portion of said second interconnect layer is optically-conductive, said second interconnect layer comprising at least one photonic element configured to implement a respective operation upon optical signals.

23. A method according to claim 21, wherein at least one of said photonic elements comprises a photonic logic gate configured to perform a respective logic operation upon optical logic signals.
